(19) United States
(12) Patent Application Publication
(10) Pub. No.: US 2016/0207079 A1
(43) Pub. Date: Jul. 21, 2016

(54) CONTINUOUS BACK SEAL WASHING FOR PUMP SYSTEMS

(71) Applicant: Malvern Instruments Incorporated, Westborough, MA (US)

(72) Inventor: Brian L. KELLER, Tomball, TX (US)

(73) Assignee: Malvern Instruments Incorporated, Westborough, MA (US)

(21) Appl. No.: 14/599,033

(22) Filed: Jan. 16, 2015

(51) Int. Cl. B08B 9/032; F04B 53/14; G01N 30/02; F04B 19/22

(52) U.S. Cl. CPC B08B 9/0321; F04B 19/22; F04B 53/143; G01N 30/02; G01N 2030/027

(57) ABSTRACT

The present disclosure is directed to pump systems for continuously washing back seal areas of the pump. These systems can continuously wash the back seal areas of a pump by using the pump to pull a fluid first through the back seal wash areas of the pump and then to the pump main inlet.

### FIELD OF THE INVENTION

This invention relates to continuously washing back seal areas for pump systems. More particularly, this invention relates to pump systems wherein the fluid fed to the pump main inlet is first fed to the back seal areas of the pump using the pump to provide the force needed to pull the fluid through the back seal areas.

### BACKGROUND OF THE INVENTION

Chromatography is a technique used for the separation, identification, and quantification of components of liquid and gaseous mixtures. Typical chromatography systems employ a pump to provide a flow of the mixture in the system. For example, liquid chromatography generally requires that a sample that is to be separated/analyzed be transported in a mobile phase fluid, and conveyed by that fluid to a stationary phase such as a chromatography column. In such a liquid chromatography system, the pump provides a metered, controlled flow rate of this mobile phase through the system to the column at a desired pressure.

Many chromatography systems utilize reciprocating piston pumps to provide flow to the system. An example of such a reciprocating piston pump is illustrated in FIGS. 1A-1B. FIG. 1A depicts a cross-section of a piston pump head towards the end its suction stroke. FIG. 1B depicts a cross-section of a piston pump head towards the end of its discharge stroke. As shown in FIGS. 1A-1B, the piston 101 can move in and out of the pump chamber 102. In addition, there is an inlet check valve 104 and an outlet check valve 105 attached to the pump head. When the piston 101 moves out (i.e., suction), low pressure in the pump chamber 102 causes fluid to enter the chamber (depicted as dotted arrow) through the inlet check valve 104. The inlet check valve 104 can allow fluid to flow into the pump chamber 102, but not out of the chamber. When the piston 101 moves in (i.e., discharge), high pressure in the pump chamber 102 causes fluid to exit the chamber (depicted as dotted arrow) through the outlet check valve 105. The outlet check valve 105 can allow fluid to flow out of the pump chamber 102, but not into the chamber.

In addition, the piston can have a seal 106. As the piston retracts from the cylinder, the vast majority of the fluid can be wiped by the seal itself. However, a small amount of fluid can remain on the surface of the piston and pass through the seal. This fluid can contain particulates, salts, and/or other non-volatile components that will remain on the piston surface as the fluid evaporates. These components can continue to build up on the surface of the piston. In addition, with each stroke of the piston, these particulates can be pushed back into the seal. This can result in scoring of the seals (which is a primary cause of seal failure in this style of pump) and even scoring of the pistons in some cases. The scoring of the seals can also cause introduction of these particulates into the fluidic path which can foul/damage the check valves or cause downstream blockages among other downstream problems. This damage can cause numerous problems with the pump system's performance including disrupting fluid flow. Once the scoring process begins, the rate of fluid that leaks through the seal can increase over time, thereby increasing the amount of non-volatile deposit on the piston. This accumulation can snowball resulting in rapid seal degradation and ultimately seal failure.

Some have suggested that the buildup of nonvolatile material behind the seal (i.e., the back seal area) can be reduced by employing two seals on the piston wherein the seals are dimensioned and separated so that the piston stroke is less than the distance between the outer ends of the seals so that the portion of the piston surface wetted by the liquid being pumped does not become exposed to the atmosphere on the suction stroke as described in GB 2218474.

Other have suggested that by keeping the piston wet by flushing the volume behind the seals (i.e., the back seal area), the buildup of nonvolatile material can be reduced and the seal life can increase as described in EP 095448 A1 and WO 2003/078018. Traditionally, the volumes behind the seals in pump systems are flushed in one of two ways: (1) by flushing the back seal area using a separate pumping system; or (2) periodically manually flushing the back seal area with a syringe or other manual operation. However, using a separate pumping system to flush the back seal areas increases cost and maintenance required for the overall pump system. In addition, manually flushing the back seal area requires an operator to remember to manually flush the back seal area. Accordingly, back seal area flushing can often be overlooked. As a direct result of the cost of either purchasing and maintaining a secondary flushing pump or manually flushing the back seal area, some operators of pump systems tend to forego flushing which can result in reduced seal life, increased operating costs, and increased equipment downtime. Furthermore, the seal damage in a pump system is often multiplied as many pump systems employ more than one piston and thus more than one seal which can be damaged or even fail.

Accordingly, there is a need to find an improved way to reduce buildup of nonvolatile material and increase seal life while keeping cost and operator error low in pump systems.

### SUMMARY OF THE INVENTION

Applicants have discovered a cost-effective method that can reduce the buildup of nonvolatile material in back seal areas of a pump, thereby reducing the damage to the primary seal caused by this nonvolatile material. Applicants have discovered that the back seal area (i.e., a wash chamber or a void space) can be continuously washed by using the pumped fluid (i.e., mobile phase fluid) itself as the washing agent and the pump itself to provide the force needed to move the fluid through the back seal area. The force can be generated by the suction action of the pump that moves fluid into the pump cylinder. The same force that draws the fluid from the fluid supply can draw the fluid from the fluid supply through the back seal area first and then to the pump inlet.

Described are methods of continuously washing back seal areas for pump systems. More particularly, described are pump systems that can continuously wash the back seal areas of a pump by using the pump to pull a fluid from a fluid supply through the back seal wash areas of the pump and into the pump main inlet.

Some embodiments include a device that can include a seal, a piston extending through the seal, a first chamber on a first side of the seal, and a second chamber on a second side of the seal. A fluid can be moved from the second chamber to the first chamber of the device. The fluid can be moved by a force generated by a piston suction stroke. In addition, a composition of the fluid can be constant. The device can include a second seal wherein the second chamber can include an area between the first seal and the second seal that surrounds the piston. Furthermore, the device can include a second seal, a second piston extending through the second seal, a third chamber on a first side of the second seal, and a fourth chamber on a second side of the second seal. The fluid can be moved from the second and fourth chambers to the first or third chamber.

Some embodiments include a system that can include a fluid supply and a pump including a chamber fluidly connected to the fluid supply and a pump inlet fluidly connected to the chamber. A fluid can be moved from the fluid supply through the chamber to the pump inlet. The fluid can be moved using a force generated by a piston suction stroke of the pump. The pump can include a second chamber fluidly connected in series between the first chamber and the pump inlet. The pump can include a second chamber fluidly connected in parallel with the first chamber to the fluid supply and the pump inlet. The fluid can be moved from the fluid supply through the first and second chambers to the pump inlet. The system can include an HPLC system. In addition, the fluid can have a constant composition.

Some embodiments include a fluid supply and a pump including a chamber fluidly connected to the fluid supply and a pump inlet fluidly connected to the chamber and fluidly connected to the fluid supply. A first portion of a fluid can be moved from the fluid supply to the pump inlet and a second portion of the fluid can be moved from the fluid supply through the chamber to the pump inlet. The fluid can be moved using a force generated by a piston suction stroke of the pump. In addition, the first and second portions of the fluid from the fluid supply can be proportioned by a first flow path resistance between the fluid supply and the pump inlet and a second flow path resistance between the fluid supply and the chamber. The first flow path resistance can be lower than the second flow path resistance. The system can include an HPLC system. In addition, the fluid can have a constant composition.

Some embodiments include a method that can include moving a fluid through a wash chamber of a pump and then moving the fluid into a pump chamber of the pump. A force from the pump can move the fluid from the wash chamber to the pump chamber. The force can be generated by a piston suction stroke of the pump. In addition, the fluid composition can be constant.

It is understood that aspects and embodiments of the invention described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

Additional advantages of this invention will become readily apparent to those skilled in the art from the following detailed description. As will be realized, this invention is capable of different embodiments, and its details are capable of modifications in various obvious respects, all without departing from this invention. Accordingly, the examples and description are to be regarded as illustrative in nature and not as restrictive.

### BRIEF DESCRIPTION OF THE DRAWINGS

Exemplary embodiments of the invention will now be described with reference to the accompanying figures, in which:

FIG. 1A illustrates an example cross section of a piston pump head towards the end of the suction stroke.

FIG. 1B illustrates an example cross section of a piston pump head towards the end of a discharge stroke.

FIG. 2 illustrates an example of a typical flow path for a liquid chromatography process.

FIG. 3 illustrates an example of a cross-section of a reciprocating pump cylinder/piston design.

FIG. 4 illustrates an example of a cross section of a single piston pump head within an embodiment of the pump system disclosed herein.

FIG. 5 illustrates an example of a single piston plumbing scheme within an embodiment of the pump system disclosed herein.

FIG. 6 illustrates an example of serial flow through multiple back seal wash areas within an embodiment of the pump system disclosed herein.

FIG. 7 illustrates an example of parallel flow through multiple back seal wash areas within an embodiment of the pump system disclosed herein.

FIG. 8 illustrates an example of a split flow to a pump main inlet and to back seal wash areas within an embodiment of the pump system disclosed herein.

### DETAILED DESCRIPTION OF THE INVENTION

Described are pump systems that continuously wash back seal areas and methods of making and using these pump systems. These pump systems include using a force generated by a pump to move fluid through a back seal area(s) prior to moving the fluid to the pump main inlet. The force can be generated by a suction force of a piston pump.

The pump systems described herein can be used in a variety of chromatography processes. Specifically, the disclosed pump systems can be used for liquid chromatography including high pressure liquid chromatography (“HPLC”). The various types of liquid chromatography include, but are not limited to, adsorption chromatography, partition chromatography, size exclusion chromatography, affinity chromatography, and ion exchange chromatography.

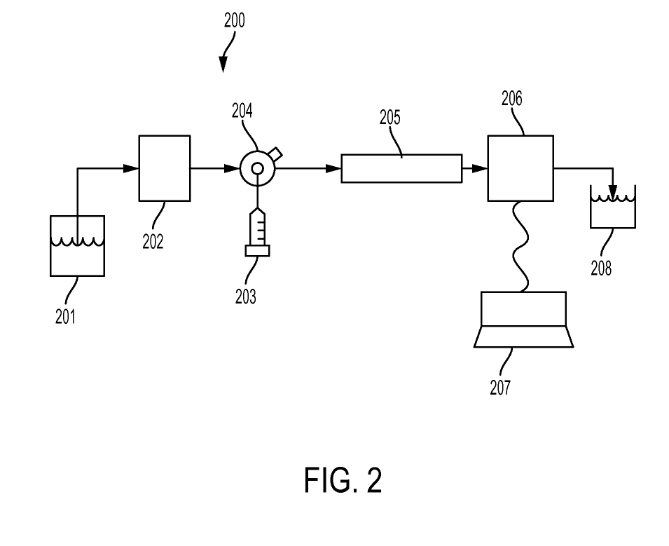

FIG. 2 illustrates a typical flow path of a liquid chromatography process 200. Specifically, the pump 202 can provide the force to move the fluid (i.e., the mobile phase) used to transport the sample to the chromatography column 205. The fluid can be a solvent, a solution, a buffer combination, or a combination of solvents, solutions, and/or buffer combination. In addition, the mobile phase can be degassed, for example by sparging or filtering, before use. The mobile phase can be chosen depending on the sample used in order to have the best separation of the components in the chromatography column. The mobile phase can be stored in a mobile phase reservoir (i.e., fluid supply) 201. The mobile phase reservoir can store multiple mobile phases. As such, depending on the mobile phase (i.e., fluid) required for the liquid chromatography process, the mobile phase used in the system can be a specific combination of various mobile phases or fluids. Generally, the mobile phase reservoirs can include inert containers to store the mobile phase. Furthermore, the composition of the mobile phase can remain constant during the chromatographic process. This is known as isocratic elution. On the contrary, the mobile phase composition can vary during the chromatographic process and can be programmed to do so before the start of the process. For example, the mobile phase composition can be programmed to vary from 75% water: 25% acetonitrile at time zero to 25% water: 75% acetonitrile at the end of the chromatographic process. This is known as gradient elution. Gradient elution can be used when there is a wide polarity range of components to be eluted. As such, the more polar components can be eluted first and the non-polar components can be eluted later in the gradient.

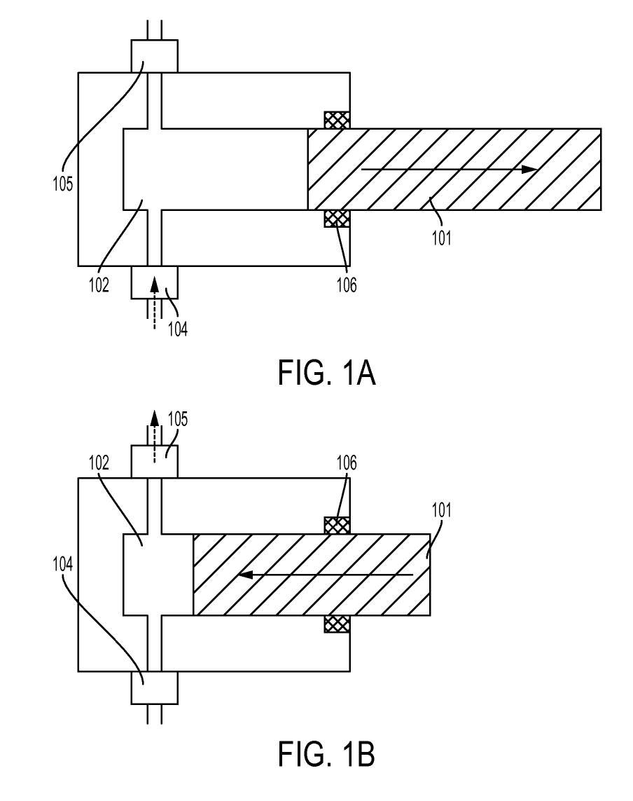

As mentioned above, the pump 202 can provide a controlled flow rate of the mobile phase throughout the chromatography process. The pump can maintain a constant flow of the mobile phase throughout the chromatography process regardless of the pressure caused by the flow resistance in the chromatography column. The pump can be a reciprocating piston pump, a syringe type pump, a constant pressure pump, or a rotary pump. In addition, the pump can include multiple pistons (one, two, three, or more), multiple seals, multiple back wash areas, and/or multiple inlet/outlet check valves. FIGS. 1A and 1B is an example of a single piston reciprocating pump. The check valves can be located at either the inlet or outlet of any individual pump chamber or at both the inlet and the outlet of an individual pump chamber. Furthermore, the pistons of a pump can be in series, in parallel, or a combination of parallel and series within the pump. For example, a dual piston pump can include two piston/cylinder heads arranged in series. The mobile phase fluid of the chromatography system can enter the pump main inlet (i.e., the inlet of the first piston head) and then travel out the outlet of the first piston head to the inlet of the second piston head. The pump main inlet can be the inlet where fluid first enters to be pressurized. The pump main inlet can be the inlet where a fluid first enters a pump chamber of the pump to be pressurized. The pump can have pump chambers in parallel; thus, the pump main inlet can be an inlet for multiple pump chambers of the pump where the fluid can be pressurized. In the dual piston pump, the pump pistons can have multiple check valves to maintain flow in one direction through the pump system. These check valves can be located at the inlet of the first pump chamber, the outlet of the first pump chamber, the inlet of the second pump chamber, and/or the outlet of the second pump chamber. In addition, the pistons in any pump can have different piston speeds, different volumes, and/or can pressurize the mobile phase in different amounts. Furthermore, after the pump 202, there can be a pulse damper(s) to reduce the pulsations in the flow. The pulsations can be from piston crossover and check valve closures.

The pump used in the chromatography process can also pressurize the mobile phase. This pressure can be used to force the mobile phase through the chromatography column under pressure which can reduce the separation time in the column. In addition, by pressurizing the mobile phase, the chromatography column can employ smaller particle size packings. The pressure employed by the pump depends on the specifics of the chromatography system and the analysis requirements. However, in HPLC, the operation pressure (i.e., the pressure of the high pressure side of the primary seal) can vary between 50 and 15,000 psi.

After the mobile phase exits the pump, an injector 204 can be used to provide a volume sample 203 into the pumped (i.e., pressurized) mobile phase. The mobile phase can then transport the sample to the chromatography column 205. The chromatography column can be packed with a stationary phase. The stationary phase can refer to the solid support contained within the column over which the mobile phase continuously flows. The type of adsorbent material used as the stationary phase can be chosen based on particle size and activity of the solid. As the sample (and the mobile phase) flow through the stationary phase, components of the sample (and the mobile phase) can migrate according to their interactions with the stationary phase. The interactions between the stationary phase and the sample with the mobile phase can determine the degree of migration and separation of the components contained in the sample. For example, those samples which have stronger interactions with the stationary phase than with the mobile phase can have a longer retention time in the column and therefore leave the column less quickly.

Once components exit the chromatography column 205, a detector 206 can detect the various components as they elute from the column. The detector can give specific responses for the components separated by the column and can provide the required sensitivity to detect such components. The detector can include, but is not limited to, an ultraviolet (UV) detector, a fluorescence detector, an electrical conductivity detector, a refractive index detector, an electrochemical detector, a light scattering detector, an IR absorbance detector, a mass-spectrometric detector, or a combination of these detectors. A data processor 207 can display and calculate all the data collected from the detectors. In addition, the data processor can also be used to control operational parameters including mobile phase composition, temperature, flow rate, injection volume, pressure, etc. The data processor can be a computer. After the components of the mobile phase and sample have been analyzed, the mobile phase and sample can be sent to the waste 208.

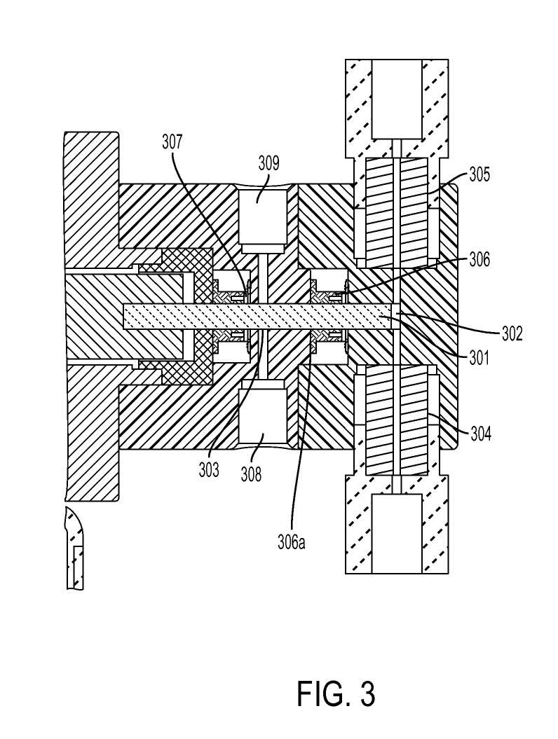

As discussed above, the pump(s) in the liquid chromatography process can include one or more pistons. FIG. 3 is an example of a cross-section of a reciprocating pump cylinder/piston design. As shown in FIG. 3, there can be two seals (a primary or main seal 306 and a secondary or back seal 307) on each piston 301. As a fluid moves through the inlet check valve 304 and out the outlet check valve 305, the fluid can be pressurized in the pump chamber 302. The primary seal 306 can prevent high pressure fluid in the pump chamber 302 from leaking around the piston and past the primary seal 306. The secondary seal 307 can form a void space 303 between the two seals. The void space 303 is also known as a back seal wash area or a wash or flush chamber. As discussed above, small amounts of the pumped fluid can remain on the surface of the piston and pass through the primary seal. In addition, the fluid can contain particulates, salts, or other non-volatile components that can buildup on the surface of the piston as this fluid evaporates. This buildup of non-volatile material can damage the primary seal while the piston is operating. Accordingly, the void space (wash chamber, back seal wash area, etc.) 303 can be flushed with fluid (i.e., a washing agent) to help lubricate the piston/primary seal interface. By lubricating the piston/primary seal interface, the buildup of non-volatile material on the surface of the piston behind the primary seal 306a (i.e., the side opposite the pump chamber also known as the low pressure side) can be reduced and even prevented.

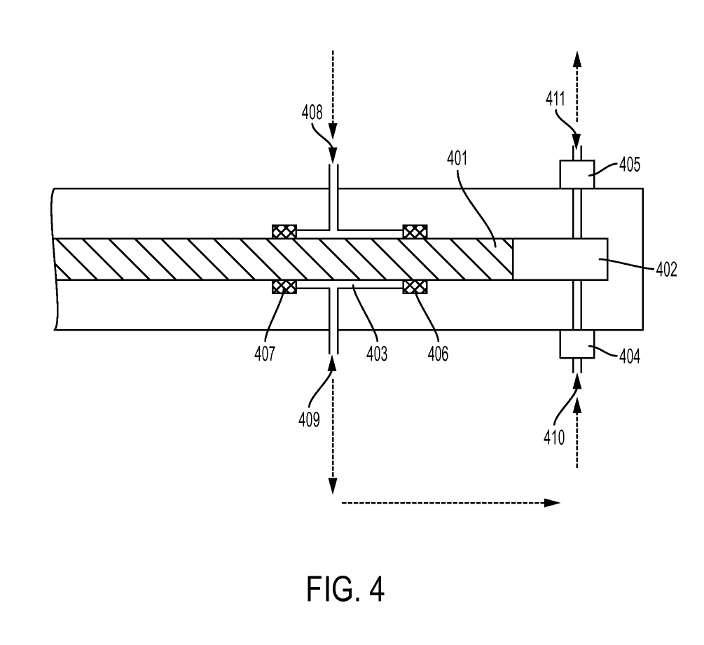

The wash chamber can include a bore through which the piston extends. A gap can be formed between the surface of the piston and the surface of the bore of the wash chamber. As such, the wash chamber can include the space or area between the primary seal and the secondary seal that surrounds the piston. (See FIG. 4 discussed below). The wash/flush chamber can be designed to receive a fluid (i.e., washing agent) behind the primary seal to keep the piston wet and prevent formation of non-volatile material buildup. The washing fluid can be introduced to the wash chamber through flush inlet 308. The washing fluid can then circumvent the portion of the piston which extends through the wash chamber and exit through flush outlet 309.

Each piston can include a primary seal, a secondary seal, and/or a wash chamber. Since a pump can include multiple pistons, a pump therefore can include multiple primary seals, multiple secondary seals, and/or multiple wash chambers. In a traditional two piston pump, there are two primary seals, each of which have the potential for the buildup of non-volatile material to occur on the “dry” side of the primary seal (i.e., area opposite the pump chamber). As such, maintaining the seals in the best possible condition is paramount to extending the usability of the pump from both a maintenance and performance stand point.

Applicants have discovered a cost-effective method that can reduce the buildup of nonvolatile material in the back seal areas of a pump, thereby reducing the damage to the primary seal caused by this nonvolatile material. Applicants have discovered that a back seal area of a pump (i.e., wash chamber or void space) can be continuously washed by using the pumped fluid (i.e., mobile phase fluid) itself as the washing agent. Specifically, the pump that pressurizes the fluid can provide the force needed to move the fluid through the back seal area. The force can be generated by a suction stroke of a piston of the pump. In order to provide a continuous flow of fluid to the back seal are, a means to generate this flow is required. Because the back seal area is normally washed whenever the pump is operating, the pump itself can generate the movement of fluid through the wash chamber. By utilizing the pump that is already continuously operating and the fluid which is going to be pressurized by the pump, the back seal area can be continuously washed in a cost effective manner.

FIG. 4 illustrates an example of a cross section of a piston pump head of a single piston pump system disclosed herein. The flow of fluid in FIG. 4 is depicted as a dotted arrow. The back seal wash inlet 408 can be fluidly connected to a fluid supply which can be fluidly connected to a wash chamber 403. The fluid supply can include the fluid (i.e., mobile phase) that is to be pressurized by the pump. The back seal wash outlet 409, which can be fluidly connected to a wash chamber 403, can be fluidly connected to a pump main inlet. The pump main inlet can be the inlet where fluid first enters to be pressurized. The pump main inlet can be the inlet for a first pump chamber in a pump containing pump chambers in series. In addition, the pump main inlet can be the inlet for pump chambers that are in parallel in a pump. Furthermore, the back seal wash outlet 409 can be fluidly connected to additional wash chambers (either in series or parallel), each having a back seal wash inlet and outlet. If the wash chambers are fluidly connected in series, the last back seal outlet in the series of wash chambers can be fluidly connected to the pump main inlet. If the wash chambers are fluidly connected in parallel, the back seal outlets of all the wash chambers in parallel can be fluidly connected to the pump main inlet. In addition, there can be a combination of wash chambers in series and parallel in which either the last wash chamber in the series or the last wash chambers in parallel can be fluidly connected to the pump main inlet.

Accordingly, a force from the pump can move the fluid in the described pump systems. Specifically, this force can be generated by at least one piston suction stroke from the pump. For example, as the piston 401 performs a suction stroke, a low pressure vacuum can be created in the pump chamber 402. As such, the low pressure within the pump chamber 402 can cause fluid to enter and fill the pump chamber 402 through the piston inlet 410 and the inlet check valve 404. The fluid that enters the pump chamber 402 can be fluid exiting a back seal wash outlet 409. Thus, as the suction stroke's force pulls fluid into the pump chamber, it also can pull fluid through the wash chamber 403 (entering through a back seal wash inlet 408 and exiting through a back seal wash outlet 409). The fluid that is pulled through the wash chamber can be from a fluid supply (i.e., mobile phase reservoir) or from another wash chamber. A fluid supply can be fluidly connected directly to a back seal wash inlet of a wash chamber. Furthermore, a back seal wash outlet of a wash chamber can be fluidly connected directly to the pump main inlet. As such, there may be no additional pump(s) (or other device) to move the washing agent (i.e., mobile phase fluid) through the pump system other than the pump that is used to pressurize the fluid. By connecting a back seal wash inlet to a fluid supply and connecting a back seal wash outlet to a pump inlet, a constant low pressure flow of fluid to the wash chamber can be provided using the pump to generate the force to move the fluid through the wash chamber and into the pump chamber. The low pressure can be relative to the operating pressure of the pump. The low pressure can be what would be provided by gravity if the fluid supply is above the inlet allowing the fluid to syphon through the supply tubing. If the fluid supply is below the pump inlet and/or the wash chamber, then the fluid would be pulled against gravity and can have slightly negative pressure.

When the piston 401 performs a discharge stroke, it can pressurize the fluid in the pump chamber 402. The high pressure in the pump chamber 402 can force the fluid out the outlet check valve 405 and piston outlet 411. The fluid exiting the piston outlet 411 can be pressurized by additional pistons in the pump or can exit the pump to be used in downstream processes such as injection with a sample and through a chromatography column.

The piston 401 has a primary seal 406 and a secondary seal 407. The wash chamber 403 can be defined as the area between the primary seal 406 and secondary seal 407 which surrounds the piston 401. By continuously flushing the wash chamber when the pump is in operation, the surface of the piston behind the primary seal can remain wet. As such, the buildup of nonvolatile material can be reduced. The secondary seal may not be at as high a risk for damage due to nonvolatile buildup behind the secondary seal because the back seal area does not experience the same high pressure that the pump chamber experiences. Accordingly, the area behind the primary seal (i.e., back seal wash area) can be at a lower pressure than the area in front of the primary seal (i.e., pump chamber). For example, the back seal wash area can be at atmospheric pressure, under no pressure, or under a slight negative pressure. The pressure in the back seal wash area can be from the suction force of a piston of the pump. All of the low pressure references can be relative to the high pressure side of the primary seal, which again can be the operating pressure of the pump. This can vary depending on the application. The back seal should not be subjected to the levels of pressure that the pumping portion of the system is exposed to. When the pressure is high in the back seal wash area, the secondary seal can suffer the same problems with leaks as the primary seal.

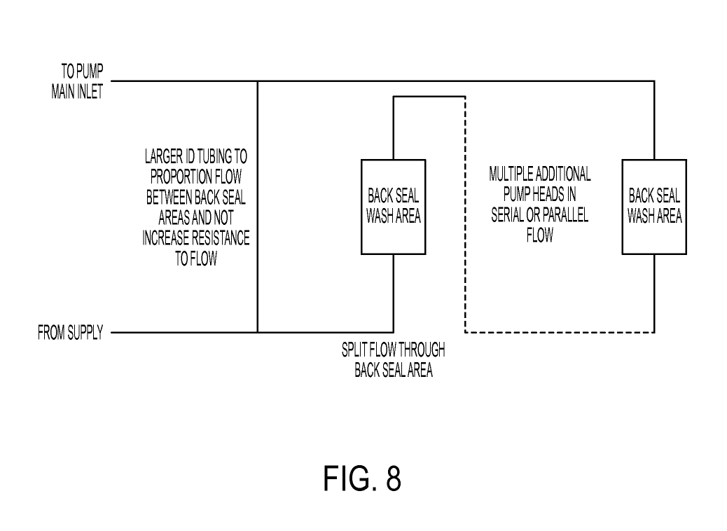

There can be a practical limit to the pressure drop across the back seal area. This pressure drop can be due to the restriction of flow through the back seal wash area and associated fittings/tubings used to make the connections to the pump main inlet. If this restriction is too high, the pump can be starved for fluid or the pressure drop can be so high that bubble formation occurs. The pressure drop can be related to the flow rate, viscosity of the fluid, and the length and average cross section area of the flow path among other factors. Splitting the flow between different channels (see FIG. 8 and description below) can reduce the mass flow in a given channel. This reduced flow can reduce the actual pressure drop in the individual flow path, thereby reducing the likelihood of bubble formation or pump starvation. In addition, if a fluid has a high vapor pressure or high dissolved gas content, it may not tolerate as high a pressure drop as a low vapor pressure fluid or one with low dissolved gas content.

A key to continuously washing the back seal areas is to reduce the pressure drop so that the fluid can be pulled through the back seal wash area without causing bubble to form or restrict the pump supply. The key is to keep the pressure low for the back seal wash area. An optimal pressure drop is 0, but the pressure drop can vary depending on flow rate, viscosity, and geometry of flow path among others.

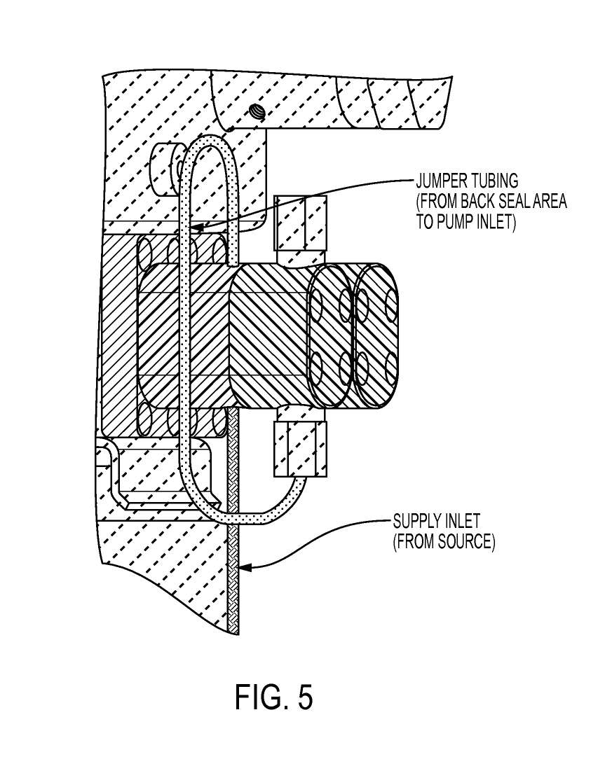

FIG. 5 illustrates an example of a single piston plumbing scheme within an embodiment of the pump system disclosed herein. Specifically, FIG. 5 shows a fluid supply inlet entering the back seal wash area (i.e., wash chamber) from the “bottom.” By flowing the fluid through the bottom of a wash chamber, the flow of fluid can aid in flushing bubbles out of the wash chamber via gravity. The fluid can then pass through the wash chamber and out the “top” of the wash chamber into a jumper that can be fluidly connected to either the pump main inlet (as shown) or more commonly to the “bottom” of any remaining wash chambers and then to the pump main inlet. The jumper(s) can be any fluid compatible tubing with minimal resistance to flow at the flow rates anticipated for the pumping system. In addition, the jumpers can be integrated into the pump head.

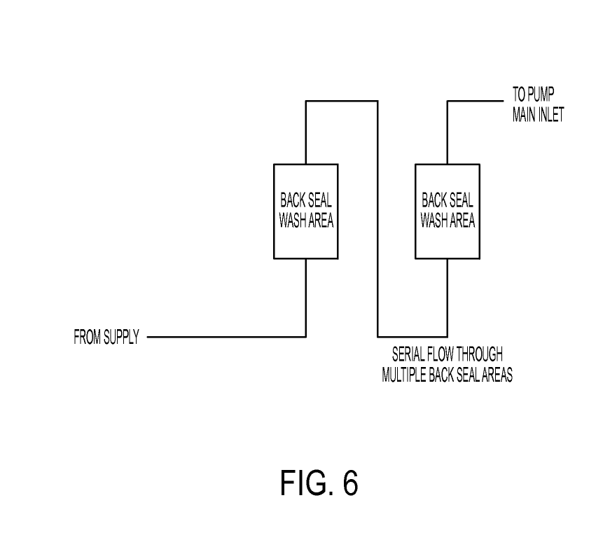

FIG. 6 illustrates an example of serial flow through multiple back seal wash areas. As shown in FIG. 6, after the fluid flows through a first back seal wash area (i.e., a first wash chamber), the fluid can sequentially flow through any remaining back seal wash areas. The back seal wash areas can be fluidly connected to each other using jumpers. In addition, after exiting a back seal wash area, the fluid can enter the bottom of another back seal wash area. After the fluid exits the final back seal wash area in the series, the fluid can flow to a pump main inlet. As previously stated, the pump main inlet can be the inlet where fluid first enters to be pressurized. As such, the pump main inlet can be an inlet to a first pump chamber of a pump including a series of pump chambers or an inlet for pump chambers that are in parallel in a pump. By having the fluid flow through the wash chambers in parallel, the total flow through each wash chamber can be reduced, thereby reducing the likelihood of bubble formation. In addition, the wash chambers are often a part of the pumps themselves. As such, the pump main inlet should not be confused as a different, separate pump from the pump that contains the wash chambers. Instead, a single pump can include the wash chamber(s) and the pump main inlet. Accordingly, besides the fluid supply, the rest of the flowchart depicted in FIG. 6 can occur within a single pump.

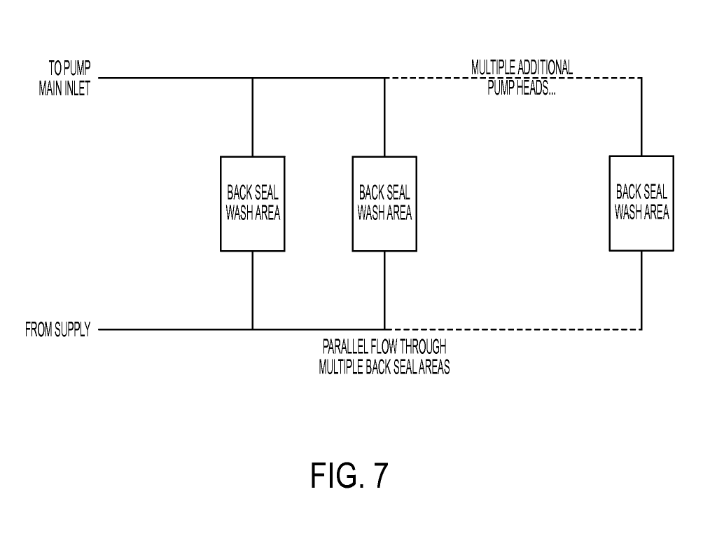

A similar approach to reduce the pressure drop and lower the chance of bubble formation can be to have the back seal wash areas (i.e., the wash chambers) in parallel. FIG. 7 illustrates an example of parallel flow through multiple back seal wash areas from a fluid supply. As shown in FIG. 7, the fluid can simultaneously flow through the back seal wash areas. The outlets of these back seal wash areas can be combined and enter the pump main inlet. All connections between the back seal wash areas and between the back seal wash areas and the pump main inlet can be fluidly connected by jumpers. In addition, the fluid can enter the bottom of these back seal wash areas. Similar to FIG. 6, besides the fluid supply, the rest of the flowchart depicted in FIG. 7 can occur within a single pump.

In some embodiments, a split flow can be employed, wherein only a portion of the fluid from the fluid supply passes through the back seal wash areas and then to the pump main inlet. The other portion can flow directly to the pump main inlet. This can be achieved by using different resistance tubing in parallel with one high resistance flow path from the fluid supply to the back seal wash area(s) (the back seal wash areas can be in series or parallel) and a lower resistance flow path from the fluid supply to the pump main inlet. The flow can be proportioned between the two paths much like the current in an electrical circuit with the lower resistance flow path having a higher flow rate. The two flow paths (higher resistance flow path and lower resistance flow path) can recombine to flow to the pump main inlet. Employing a split flow method may be practical in cases where a preexisting pump design is to be retrofitted with the disclosed continuous washing of the back seal areas. FIG. 8 illustrates an example of the described split flow to a pump main inlet and to back seal wash areas. A split flow can reduce the pressure drop so that the pump does not starve and/or bubble formation does not occur. Similar to FIG. 6 and FIG. 7, besides the fluid supply and sometimes the split flow, the rest of the flowchart can occur within a single pump. In addition, the split flow can be employed by any flow restriction device such as a proportioning valve.

The continuous back seal wash pump system described herein can be employed in isocratic elution and gradient elution, meaning that the fluid (i.e., mobile phase) being pumped can have a constant composition or the composition can change over time. Typically the continuous back seal wash pump system described herein is employed in isocratic elution. Isocratic elution is used in most size exclusion chromatography/gel permeation chromatography systems even if the hardware is capable of gradient flows. For systems that require gradient operations, high pressure mixing can be employed. Low pressure mixing can refer to mixing more than one fluid and pumping this mixed fluid through the pump. In contrast, high pressure mixing can refer to using two separate pumps for two separate fluids going to a single mixing point. Accordingly, the mixing point can be on the downstream side of the pump in a high pressure mixing system and on the upstream side of the pump in a low pressure mixing system.

High pressure mixing can be used because there can be lag in composition due to the increased volume between the metering valve and the pump main inlet. This lag can result in limiting the ramp rate with any composition gradient which can lead to degraded resolution for analytes. There may also be some cross talk between the low pressure and high pressure sides of the primary seal which can result in small and possibly random variations in composition due to the afore mentioned volumetric delay in the system (i.e., the high pressure side of the seal can have a different composition than the low pressure side of the seal which can result in ghost peaks and other artefacts). High pressure mixing may be preferred from a performance standpoint since low pressure metering systems can have considerable lag in composition versus apparent elution volume, whereas high pressure metering can generate a high resolution and faster response in gradient.

Although reciprocating piston pumps including single piston pumps are primarily described throughout the detailed description section, almost any pumping system, even rotary style pumps, can benefit from the continuous lubrication and washing of the normally “dry” side of the high pressure primary seal by moving the pumped fluid first across the low pressure (“dry”) side of the primary seal.

All of the fittings used to make any connection disclosed herein can be air tight in order to prevent air being moved (i.e., pulled) into the pump system. Applicants have discovered that degassing the fluid prior to moving it through the back seal wash areas can help prevent bubble formation. In addition, using the largest practical bore tubing can reduce the resistance to flow, thereby further helping to prevent bubble formation as well.

Any of these back seal wash areas (i.e., wash chambers) can be back seal wash areas of any or all the pump chambers or pistons in the pump. As such, a force generated by the pump can move (i.e., pull) fluid from a fluid supply through any or all of the back seal wash areas in the pump and then into the pump chambers (through the pump main inlet) where it can be pressurized. In addition, a portion of the fluid from the fluid supply can be moved directly to the pump main inlet, thereby bypassing the back seal wash areas of the pump. By using a force of the pump to move the fluid through the back seal wash areas before pressurizing the fluid, the system can continuously wet or flush the back seal wash areas while the pump is operating. Accordingly, the fluid that is pumped, first can flow through the wash chambers of the pump prior to being pumped (i.e., pressurized). In addition, any fluid that slips through the primary seal can be collected by the fluid moving through the back seal wash area. As such, fluid loss can be minimized.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A device comprising:
a seal,
a piston extending through the seal,
a first chamber on a first side of the seal, and
a second chamber on a second side of the seal,
wherein a fluid is moved from the second chamber to the first chamber.

2. The device of claim 1, wherein the fluid is moved using a force generated by a piston suction stroke.

3. The device of claim 1, wherein a composition of the fluid is constant.

4. The device of claim 1, comprising a second seal, wherein the second chamber comprises an area between the first seal and the second seal that surrounds the piston.

5. The device of claim 1, comprising:
a second seal,
a second piston extending through the second seal,
a third chamber on a first side of the second seal, and
a fourth chamber on a second side of the second seal,
wherein the fluid is moved from the second and fourth chambers to the first or third chamber.

6. A system comprising:
a fluid supply, and
a pump comprising:
a chamber fluidly connected to the fluid supply, and
a pump inlet fluidly connected to the chamber,
wherein a fluid is moved from the fluid supply through the chamber to the pump inlet.

7. The system of claim 6, wherein the fluid is moved using a force generated by a piston suction stroke of the pump.

8. The system of claim 6, wherein the pump comprises a second chamber fluidly connected in series between the first chamber and the pump inlet.

9. The system of claim 8, wherein the fluid is moved from the fluid supply through the first and second chambers to the pump inlet.

10. The system of claim 6, wherein the pump comprises a second chamber fluidly connected in parallel with the first chamber to the fluid supply and the pump inlet.

11. The system of claim 10, wherein the fluid is moved from the fluid supply through the first and second chambers to the pump inlet.

12. The system of claim 6, wherein the system comprises an HPLC system.

13. The system of claim 6, wherein a composition of the fluid is constant.

14. A system comprising:
a fluid supply, and
a pump comprising:
a chamber fluidly connected to the fluid supply, and
a pump inlet fluidly connected to the chamber and fluidly connected to the fluid supply,
wherein a first portion of a fluid is moved from the fluid supply to the pump inlet and a second portion of the fluid is moved from the fluid supply through the chamber to the pump inlet.

15. The system of claim 14, wherein the fluid is moved using a force generated by a piston suction stroke of the pump.

16. The system of claim 14, wherein the first and second portions of the fluid from the fluid supply are proportioned by a first flow path resistance between the fluid supply and the pump inlet and a second flow path resistance between the fluid supply and the chamber.

17. The system of claim 16, wherein the first flow path resistance is lower than the second flow path resistance.

18. The system of claim 14, wherein the system comprises an HPLC system.

19. The system of claim 14, wherein a composition of the fluid is constant.

20. A method, comprising:
moving a fluid through a wash chamber of a pump, and
after moving the fluid through the wash chamber of the pump, moving the fluid into a pump chamber of the pump.

21. The method of claim 20, wherein a force from the pump moves the fluid from the wash chamber to the pump chamber.

22. The method of claim 21, wherein the force is generated by a piston suction stroke of the pump.

23. The method of claim 20, wherein a composition of the fluid is constant.
